(19) United States
(12) Patent Application Publication
(10) Pub. No.: US 2026/0300823 A1
(43) Pub. Date: Oct. 1, 2026

(54) System, Method, and Computer Program Product for Adversarial Training for Collaborative Filtering

(71) Applicant: Visa International Service Association, San Francisco, CA (US)

(72) Inventors: Huiyuan Chen, San Jose, CA (US); Vivian Wan Yin Lai, Atlanta, GA (US); Xiaoting Li, Sunnyvale, CA (US); Michael Yeh, Newark, CA (US); Yujie Fan, Cleveland Heights, OH (US); Yan Zheng, Los Gatos, CA (US); Mahashweta Das, Campbell, CA (US); Hao Yang, San Jose, CA (US)

(21) Appl. No.: 19/477,142

(22) PCT Filed: Apr. 19, 2024
(86) PCT No.: PCT/US2024/025364

§ 371 Date: Oct. 21, 2025

Related U.S. Application Data
(60) Provisional application No. 63/460,918, filed on Apr. 21, 2023.

(51) Int. Cl. G06N 20/00; G06Q 30/0601

(52) U.S. Cl. CPC G06N 20/00; G06Q 30/0631

(57) ABSTRACT

Provided is a system, method, and computer program product for adversarial training for collaborative filtering. The system includes at least one processor programmed or configured to train a collaborative filtering model through a plurality of iterations by inputting a training data set including adversarial perturbations, update weights of the collaborative filtering model after each iteration or subset of iterations of the plurality of iterations, determine a training loss between each consecutive iteration or subset of iterations of the plurality of iterations, resulting in a plurality of training losses, and determine a loss function for the collaborative filtering model by minimizing a difference between an initial training loss and the plurality of training losses for the plurality of iterations.

### CROSS REFERENCE TO RELATED APPLICATIONS

This application is the United States national phase of International Application No. PCT/US24/25364 filed Apr. 19, 2024 and claims priority to U.S. Provisional Patent Application No. 63/460,918, filed Apr. 21, 2023, the disclosures of which are hereby incorporated by reference in their entireties.

### BACKGROUND

### 1. Technical Field

This disclosure relates generally to collaborative filtering, machine-learning and, in some non-limiting embodiments or aspects, to systems, methods, and computer program products for adversarial training for collaborative filtering.

### 2. Technical Considerations

Recommendation systems have become an essential part of users' engagement with online web services, such as e-commerce marketplaces and subscription streaming services. To help users discover potential items of interests, collaborative filtering is used based on similar users that tend to have similar preferences based on their historical profiles. Compared to content-based recommendation methods, collaborative filtering relies on past user behaviors to predict users' preferences on candidate items. Existing techniques to optimize collaborative filtering models result in non-robust models that are vulnerable to adversarial perturbations and with results that cannot be explained.

### SUMMARY

According to non-limiting embodiments or aspects, provided is a system comprising at least one processor programmed or configured to: train a collaborative filtering model through a plurality of iterations by inputting a training data set comprising adversarial perturbations; update weights of the collaborative filtering model after each iteration or subset of iterations of the plurality of iterations; determine a training loss between each consecutive iteration or subset of iterations of the plurality of iterations, resulting in a plurality of training losses; and determine a loss function for the collaborative filtering model by minimizing a difference between an initial training loss and the plurality of training losses for the plurality of iterations.

In non-limiting embodiments or aspects, minimizing the difference comprises minimizing a trajectory of the plurality of training losses for the plurality of iterations. In non-limiting embodiments or aspects, the at least one processor is further configured to determine the trajectory of the plurality of training losses based on angles between gradients from the plurality of iterations. In non-limiting embodiments or aspects, the at least one processor is further configured to train the collaborative filtering model based on the loss function. In non-limiting embodiments or aspects, the at least one processor is further configured to generate a recommendation of an item for a user based on the collaborative filtering model. In non-limiting embodiments or aspects, the loss function is based on a sharpness measure of the plurality of training losses. In non-limiting embodiments or aspects, the training data set comprises a plurality of vectors representing a plurality of matrices, each matrix representing a user and an item from a plurality of users and a plurality of items.

According to non-limiting embodiments or aspects, provided is a method comprising: training, with at least one processor, a collaborative filtering model through a plurality of iterations by inputting a training data set comprising adversarial perturbations; updating, with at least one processor, weights of the collaborative filtering model after each iteration or subset of iterations of the plurality of iterations; determining, with at least one processor, a training loss between each consecutive iteration or subset of iterations of the plurality of iterations, resulting in a plurality of training losses; and determining, with at least one processor, a loss function for the collaborative filtering model by minimizing a difference between an initial training loss and the plurality of training losses for the plurality of iterations.

In non-limiting embodiments or aspects, minimizing the difference comprises minimizing a trajectory of the plurality of training losses for the plurality of iterations. In non-limiting embodiments or aspects, the trajectory of the plurality of training losses is determined based on angles between gradients from the plurality of iterations. In non-limiting embodiments or aspects, the method further comprises training the collaborative filtering model based on the loss function. In non-limiting embodiments or aspects, the method further comprises generating a recommendation of an item for a user based on the collaborative filtering model. In non-limiting embodiments or aspects, the loss function is based on a sharpness measure of the plurality of training losses. In non-limiting embodiments or aspects, the training data set comprises a plurality of vectors representing a plurality of matrices, each matrix representing a user and an item from a plurality of users and a plurality of items.

According to non-limiting embodiments or aspects, provided is a computer program product comprising at least one non-transitory computer-readable medium including program instructions that, when executed by at least one processor, cause the at least one processor to: train a collaborative filtering model through a plurality of iterations by inputting a training data set comprising adversarial perturbations; update weights of the collaborative filtering model after each iteration or subset of iterations of the plurality of iterations; determine a training loss between each consecutive iteration or subset of iterations of the plurality of iterations, resulting in a plurality of training losses; and determine a loss function for the collaborative filtering model by minimizing a difference between an initial training loss and the plurality of training losses for the plurality of iterations.

In non-limiting embodiments or aspects, minimizing the difference comprises minimizing a trajectory of the plurality of training losses for the plurality of iterations. In non-limiting embodiments or aspects, the instructions further cause the at least one processor to determine the trajectory of the plurality of training losses based on angles between gradients from the plurality of iterations. In non-limiting embodiments or aspects, the instructions further cause the at least one processor to train the collaborative filtering model based on the loss function. In non-limiting embodiments or aspects, the instructions further cause the at least one processor to generate a recommendation of an item for a user based on the collaborative filtering model.

Other non-limiting embodiments or aspects will be set forth in the following numbered clauses:

Clause 1: A system comprising at least one processor programmed or configured to: train a collaborative filtering model through a plurality of iterations by inputting a training data set comprising adversarial perturbations; update weights of the collaborative filtering model after each iteration or subset of iterations of the plurality of iterations; determine a training loss between each consecutive iteration or subset of iterations of the plurality of iterations, resulting in a plurality of training losses; and determine a loss function for the collaborative filtering model by minimizing a difference between an initial training loss and the plurality of training losses for the plurality of iterations.

Clause 2: The system of clause 1, wherein minimizing the difference comprises minimizing a trajectory of the plurality of training losses for the plurality of iterations.

Clause 3: The system of clause 1 or 2, wherein the at least one processor is further configured to determine the trajectory of the plurality of training losses based on angles between gradients from the plurality of iterations.

Clause 4: The system of any of clauses 1-3, wherein the at least one processor is further configured to train the collaborative filtering model based on the loss function.

Clause 5: The system of any of clauses 1-4, wherein the at least one processor is further configured to generate a recommendation of an item for a user based on the collaborative filtering model.

Clause 6: The system of any of clauses 1-5, wherein the loss function is based on a sharpness measure of the plurality of training losses.

Clause 7: The system of any of clauses 1-6, wherein the training data set comprises a plurality of vectors representing a plurality of matrices, each matrix representing a user and an item from a plurality of users and a plurality of items.

Clause 8: A method comprising: training, with at least one processor, a collaborative filtering model through a plurality of iterations by inputting a training data set comprising adversarial perturbations; updating, with at least one processor, weights of the collaborative filtering model after each iteration or subset of iterations of the plurality of iterations; determining, with at least one processor, a training loss between each consecutive iteration or subset of iterations of the plurality of iterations, resulting in a plurality of training losses; and determining, with at least one processor, a loss function for the collaborative filtering model by minimizing a difference between an initial training loss and the plurality of training losses for the plurality of iterations.

Clause 9: The method of clause 8, wherein minimizing the difference comprises minimizing a trajectory of the plurality of training losses for the plurality of iterations.

Clause 10: The method of clause 8 or 9, wherein the trajectory of the plurality of training losses is determined based on angles between gradients from the plurality of iterations.

Clause 11: The method of any of clauses 8-10, further comprising training the collaborative filtering model based on the loss function.

Clause 12: The method of any of clauses 8-11, further comprising generating a recommendation of an item for a user based on the collaborative filtering model.

Clause 13: The method of any of clauses 8-12, wherein the loss function is based on a sharpness measure of the plurality of training losses.

Clause 14: The method of any of clauses 8-13, wherein the training data set comprises a plurality of vectors representing a plurality of matrices, each matrix representing a user and an item from a plurality of users and a plurality of items.

Clause 15: A computer program product comprising at least one non-transitory computer-readable medium including program instructions that, when executed by at least one processor, cause the at least one processor to: train a collaborative filtering model through a plurality of iterations by inputting a training data set comprising adversarial perturbations; update weights of the collaborative filtering model after each iteration or subset of iterations of the plurality of iterations; determine a training loss between each consecutive iteration or subset of iterations of the plurality of iterations, resulting in a plurality of training losses; and determine a loss function for the collaborative filtering model by minimizing a difference between an initial training loss and the plurality of training losses for the plurality of iterations.

Clause 16: The computer program product of clause 15, wherein minimizing the difference comprises minimizing a trajectory of the plurality of training losses for the plurality of iterations.

Clause 17: The computer program product of clause 15 or 16, wherein the instructions further cause the at least one processor to determine the trajectory of the plurality of training losses based on angles between gradients from the plurality of iterations.

Clause 18: The computer program product of any of clauses 15-17, wherein the instructions further cause the at least one processor to train the collaborative filtering model based on the loss function.

Clause 19: The computer program product of any of clauses 15-18, wherein the instructions further cause the at least one processor to generate a recommendation of an item for a user based on the collaborative filtering model.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings and appendices are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for adversarial training for collaborative filtering according to some non-limiting embodiments or aspects;

FIG. 2 is another schematic diagram of a system for adversarial training for collaborative filtering according to some non-limiting embodiments or aspects;

FIG. 3 is a flow diagram of a method for adversarial training for collaborative filtering according to some non-limiting embodiments or aspects;

FIG. 4 is another schematic diagram of a system for adversarial training for collaborative filtering according to some non-limiting embodiments or aspects; and

FIG. 5 is a schematic diagram of example components of one or more devices according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

An “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for adversarial training for collaborative filtering that improve upon existing methods and techniques. For example, non-limiting embodiments may avoid the use of pairwise ranking objectives, such as a Bayesian Personalized Ranking (BPR) loss term, without compromising performance or computational efficiency. Moreover, non-limiting embodiments uniquely separate a loss function into at least two components. Through the use of adversarial perturbations during the training process, a robust collaborative filtering model can be created. Non-limiting embodiments accelerate adversarial training by making the loss landscape smoother, leading to a model with improved generalizability across different types of data. Non-limiting embodiments can provide results that are twice as fast as existing adversarial training methods.

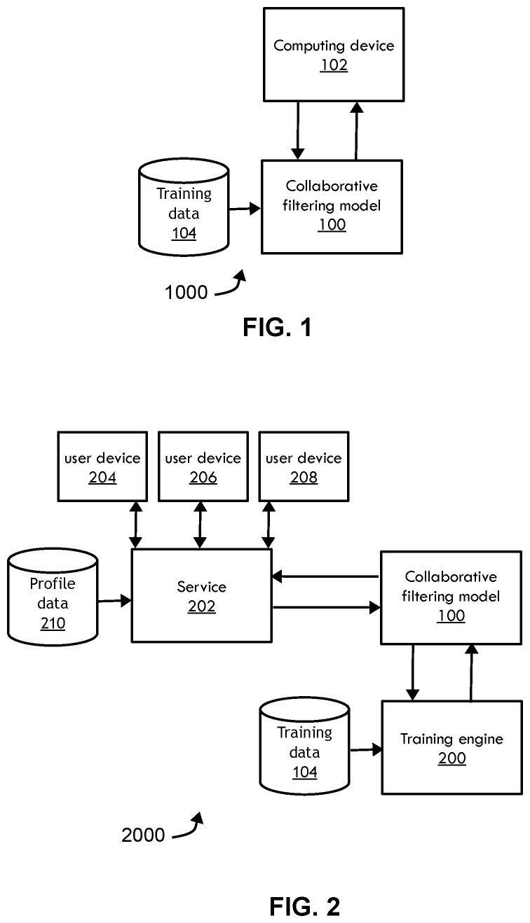

Referring to FIG. 1, shown is a system 1000 for adversarial training for collaborative filtering according to non-limiting embodiments or aspects. The system includes a computing device 102, such as at least one processor, in communication with a collaborative filtering model 100. The collaborative filtering model 100 may be configured to, for example, provide an output of recommendations for a user based on inputs from multiple different users and parameters shared between the user and the multiple different users. It will be appreciated that various forms of collaborative filtering models and algorithms may be used. The collaborative filtering model 100 may be a machine-learning model that is trained and updated.

With continued reference to FIG. 1, the computing device 102 may orchestrate a training process for the collaborative filtering model 100 by iterating through training inputs from training data 104. The training data 104 may include adversarial perturbations and/or may be modified by the computing device 102 and/or another device to include adversarial perturbations before being input into the collaborative filtering model 100. After each iteration or subset of iterations, the weights of the collaborative filtering model are updated. For example, the weights may be updated by the computing device 102 after each iteration (e.g., after each input and corresponding output) or may be updated after multiple iterations (e.g., a subset of iterations) such that one or more iterations are skipped before updating the weights. It will be appreciated that other arrangements are possible.

Still referring to FIG. 1, the computing device 102 may determine a training loss between each consecutive iteration or subset of iterations of the plurality of iterations, resulting in a plurality of training losses. For example, a training loss may be determined after the weights are updated following an iteration or subset of iterations. The computing device 102 may then determine a loss function for the collaborative filtering model by minimizing a trajectory of the plurality of training losses for the plurality of iterations. The trajectory of training losses may be determined based on angles between gradients from the plurality of iterations.

Referring to FIG. 2, shown is a system 2000 for adversarial training for collaborative filtering according to non-limiting embodiments or aspects. The system includes a collaborative filtering model 100 and training data 104 as discussed in connection with FIG. 1. The system 2000 also includes a training engine 200, which may be one or more computing devices and/or software applications executed by one or more computing devices. The training engine 200 may be configured to train the collaborative filtering model 100 with training data 104. In non-limiting embodiments, the training engine 200 may be the same and/or part of the computing device 102 shown in FIG. 1.

With continued reference to FIG. 2, the system 2000 includes a service 202, which may include one or more server computers arranged in a network environment. The service 202 may include, for example, a media streaming service (e.g., for streaming music, movies, television shows, and/or the like), a merchant system (e.g., for making purchases through a website and/or application), an issuer system (e.g., for making payments, financial transfers, and/or the like), and/or any other network-based service accessible to users, such as user devices 204, 206, 208. The service 202 may be or may include a recommendation service for providing restaurant recommendations, product recommendations, event recommendations, and/or the like.

User devices 204, 206, 208 may each include client computing devices operated by one or more end-users. Profile data 210 may include one or more data storage devices storing profile data for each user associated with user devices 204, 206, 208. The profile data may include representations of actions performed by the users, such as a purchase history, viewing history, and/or the like. In non-limiting embodiments, the profile data may include a plurality of matrices, where each matrix represents a user and at least one item of a plurality of items. The items may include, for example, streamed media, purchases products, financial products, and/or the like.

The actions performed by users may represent behaviors such as but not limited to clicking, mouse movement and/or hovering, navigation history, commenting, purchasing, and/or the like. For the calculations discussed herein, a set of users U={u} and items I={i} are analyzed.

$${I}_{u}^{+}$$

represents the items that user u has interacted with (e.g., performed an action with respect to), and

$${I}_{u}^{-} = I - {I}_{u}^{+}$$

represents unobserved items (e.g., items that the user did not perform an action with respect to). Unobserved interactions may not be treated as negative examples, but may rather represent that the user is unaware of one or more items.

Matrix factorization has been recognized as a basic yet effective model in recommendations. Being a germ of representation learning, matrix factorization represents each user u and item i as an embedding vector. A user preference for an item can be estimated as the inner product between the embedding vector for a user and for an item. A lookup table may be used for the embeddings, represented by eᵤ and eᵢ. The embeddings serve as memory of the initial characteristics of items and users. The inner product may be expressed as: ŷᵤᵢ=eᵤ^{T} eᵢ, where ŷᵤᵢ represents a preference score between user and item.

BPR is a pairwise learn-to-rank method that is used to optimize recommendation models for personalized ranking. BRP techniques target learning from implicit feedback and assumes that observed interactions should be ranked higher than unobserved interactions. To achieve this, BPR maximizes the margin between an observed interaction and its unobserved counterparts. The objective function of BPR, which is to be minimized, can be formally expressed as:

$${ℒ}_{bpr} ( Θ ) = {\sum }_{( u , i , j ) ∈ 𝒪} - ln σ ( {\hat{y}}_{ui} - {\hat{y}}_{uj} ) + α {‖ Θ ‖}_{2}^{2} ,$$

where

$$𝒪 = \{ ( u , i , j ) \vert u ∈ U ∧ i ∈ {I}_{u}^{+} ∧ j ∈ {I}_{u}^{-} \}$$

denotes the pairwise training data; σ(·) is the sigmoid function; Θ denotes model parameters, and α controls the L₂ norm to prevent over-fitting. The variable i represents an item that a user u interacts with. However, although matrix factored BPR can withstand random noise to some extent, it is vulnerable to specific, targeted perturbations. The existence of effective adversarial perturbations suggests that such a recommendation model may be overfitting to the training data and struggling to generalize effectively.

Adversarial personalized ranking (APR) aims to design a new objective function that enables a recommendation model to excel at personalized ranking while also being robust to adversarial perturbations. To achieve this, it leverages the BPR pairwise objective for personalized ranking and uses it as the foundation for training the model. APR enhances the robustness of a recommendation model by optimizing it to perform well even in the presence of adversarial perturbations. Specifically, APR optimizes the model to minimize the BPR objective function with perturbed parameters. Formally, the objective function of adversarial personalized ranking is defined as follows:

$${ℒ}_{apr} ( 𝒪 \vert Θ ) = {ℒ}_{bpr} ( 𝒪 \vert Θ ) + {λℒ}_{bpr} ( 𝒪 \vert Θ + {Δ}_{adv} ) , \\ where {Δ}_{adv} = arg {max}_{Δ , ‖ Δ ‖ \leq ρ} {ℒ}_{bpr} ( 𝒪 \vert \hat{Θ} + Δ )$$

In the above expression, Δ represents the perturbations on model parameters, ρ≥0 controls the magnitude of the perturbations, and \hat{Θ} denotes the current model parameters. In this formulation, the adversarial term L_{bpr} ( [symbol] |Θ+Δ_{adv}) acts as a regularizer, stabilizing the classification function in BPR. Thus, it refers to it as the adversarial regularizer and uses λ to control its strength. As the intermediate variable Δ maximizes the objective function to be minimized by Θ, the training process of APR can be expressed as playing a minimax game as follows:

$${Θ}^{*} , {Δ}^{*} = arg {min}_{Θ} {max}_{Δ , ‖ Δ ‖ \leq ρ} {ℒ}_{bpr} ( 𝒪 \vert Θ ) + {λℒ}_{bpr} ( 𝒪 \vert Θ + Δ ) ,$$

In the above equation, the learning algorithm for model parameters Θ is the minimizing player, and the procedure for obtaining perturbations Δ acts as the maximizing player. The maximizing player aims to identify the worst-case perturbations against the current model. The two players alternate playing the game until convergence. As the primary focus of APR is to generate a high-quality recommendation model, adversarial training can be stopped by tracking the performance of the model on a validation data set. However, APR requires two-feedforward of neural networks to compute the gradient, which is not scalable to large-scale dataset, and the output lacks explainability.

The APR contains two components: Lₐₚᵣ ( [symbol] |Θ)=L_{bpr} ( [symbol] |Θ)+λL_{bpr} ( [symbol] |Θ+Δ_{adv}). In a gradient descent algorithm, the gradient of Θ can be directly computed by λL_{bpr} ( [symbol] |Θ+Δ_{adv}). Thus, the first component L_{bpr} ( [symbol] |Θ), representing an original BPR loss, is not necessary and can be removed. The adversarial loss λL_{bpr} ( [symbol] |Θ+Δ_{adv}) may be maintained.

TABLE 1
The performance with varying λ

| Metric | λ = 0 | λ = 1 | λ = 10 | λ = 100 | λ = 1000 |
|---|---|---|---|---|---|
| Recall@5 | 0.783 | 0.809 | 0.831 | 0.842 | 0.853 |
| NDCG@5 | 0.801 | 0.824 | 0.867 | 0.872 | 0.882 |

The performance increases with a larger value of λ. To this end, the loss function of APR can be reduced to:

$${min}_{Θ} {max}_{Δ , ‖ Δ ‖ \leq ρ} {ℒ}_{bpr} ( 𝒪 \vert Θ + Δ ) ,$$

Sharpness-aware minimization (SAM) aims to encourage training to converge outputs to a flatter region in which the training losses in the neighborhood around the minimizer \hat{Θ} are lower. To achieve this, SAM proposes a training scheme that solves the following min-max optimization problem:

$${min}_{θ} {max}_{ϵ : {‖ ϵ ‖}_{2} \leq ρ} L ( {f}_{θ + ϵ} ) .$$

Here, ε is the weight perturbation vector that maximizes the training loss within the p-constrained neighborhood. The objective loss function of SAM can be rewritten as the sum of the vanilla loss and the loss associated with the sharpness measure, which is the maximized change of the training loss within the e-constrained neighborhood:

$$\hat{θ} {=}_{θ} \{ R ( {f}_{θ} ) + L ( {f}_{θ} ) \} where R ( {f}_{θ} ) = {max}_{ϵ : {‖ ϵ ‖}_{2} \leq ρ} L ( {f}_{θ + ϵ} ) - L ( {f}_{θ} ) .$$

The sharpness measure is approximated as R(f_{θ})=L(f_{θ}e+\hat{ϵ})−L(f_{θ}), where \hat{ϵ} is the solution to an approximated version of the maximization problem where the objective is the first-order Taylor series approximation of L(f_{θ}+ϵ) around θ, which can be expressed as:

$$\hat{ϵ} = arg {max}_{ϵ : {‖ ϵ ‖}_{2} \leq ρ} L ( {f}_{θ + ϵ} ) \approx ρ \frac{{∇}_{θ} {L}_{(} {f}_{θ} )}{\vert {∇}_{θ} {L}_{(} {f}_{θ} ) \vert} .$$

SAM seeks flat minima with low variation in their training losses when the optimal weights are slightly perturbed. The fact that SAM's computational cost is twice that compared to the base optimizer is its main limitation. The additional computational overhead is used to compute the sharpness term R(f_{θ}).

Non-limiting embodiments provide for a new trajectory loss function that can be used as a replacement of the sharpness loss R(f_{θ}) of a SAM-based approach without needing additional computational overhead over the base optimizer.

The sharpness measure R(f_{θ}) of SAM is modified based on its first-order Taylor expansion. Given a vector \hat{ϵ} whose norm is small, provided is:

$$\begin{matrix}R ( {f}_{θ} ) = L ( {f}_{θ + ϵ} ) - L ( {f}_{θ} ) \approx L ( {f}_{θ} ) + \hat{ϵ} {∇}_{θ} {L}_{(} {f}_{θ} ) - L ( {f}_{θ} ) \\ = ρ \frac{{{∇}_{θ} {L}_{(} {f}_{θ} )}^{T}}{‖ {∇}_{θ} {L}_{(} {f}_{θ} ) ‖} {∇}_{θ} {L}_{(} {f}_{θ} ) = ρ ‖ {∇}_{θ} {L}_{(} {f}_{θ} ) ‖\end{matrix} .$$

Minimizing the sharpness loss R(f_{θ}) corresponds to minimizing the l₂-norm of the gradient ∇_{θ}L f_{θ}), which is the same gradient used to minimize the vanilla loss L(f_{θ}). The learning rate η in the training (using stochastic gradient descent) is typically smaller than ρ as suggested by SAM. Therefore, if the mini-batch is the same for the two consecutive iterations, the change of the training loss after the weights have been updated can be approximated as follows:

$${L ( {f}_{θ} ) - L ( {f}_{θ - η {∇}_{θ} {L}_{(} {f}_{θ} )} ) \approx η ‖ {∇}_{θ} {L}_{(} {f}_{θ} ) ‖}^{2} \approx \frac{η}{{ρ}^{2}} {R ( {f}_{θ} )}^{2} .$$

The change in the training loss after the weights have been updated is proportional to R(f_{θ})². Therefore, minimizing the loss difference is equivalent to minimizing the sharpness loss of SAM. The weight update may then be used in training as an approximation of, and replacement to, the sharpness measure of SAM. The past trajectory of the weights as the iterations progress may be denoted as Θ={θ₂, θ₃, . . . , θₜ₋₁}. Therefore, θₜ represents the weights in the t-th iteration. Stochastic gradient descent techniques update the weights as θₜ₊1=θₜ−η∇_{θ}_{ₜ}. The quantity R_{B}_{ₜ} (f_{θ}_{ₜ}) as defined in the sharpness measure of R(f_{θ}) is non-negative, and can be expressed as:

$$\begin{matrix}{arg min}_{{θ}_{i}} {R}_{{𝔹}_{t}} ( {f}_{{θ}_{t}} ) = {arg min}_{{θ}_{i}} {γ}_{t} {R}_{{𝔹}_{t}} ( {f}_{{θ}_{t}} ) {R}_{{𝔹}_{t}} ( {f}_{{θ}_{t}} ) \\ = {arg min}_{{θ}_{i}} [ {γ}_{t} {R}_{{𝔹}_{t}} ( {f}_{{θ}_{t}} ) {R}_{{𝔹}_{t}} ( {f}_{{θ}_{t}} ) + {γ}_{i} {R}_{{𝔹}_{t}} ( {f}_{{θ}_{i}} ) {R}_{{𝔹}_{t}} ( {f}_{{θ}_{i}} ) ] \\ = {𝔼}_{{θ}_{i} ∼ Unif ( Θ )} [ {γ}_{i} {R}_{{𝔹}_{t}} ( {f}_{{θ}_{i}} ) {R}_{{𝔹}_{t}} ( {f}_{{θ}_{i}} ) ]\end{matrix} ,$$

In the above equation, θᵢ~Unif(Θ) means that θᵢ is uniformly distributed in the set Θ, γᵢ is defined as ηₜ/ρ₂·cos(Φᵢ), where Φᵢ is the angle between the gradients that are computed using the mini-batches i and t, respectively. For i≠t, γᵢR_{B}_{ₜ} (f_{θ}_{ₜ}) R_{B}_{ₜ} (f_{θ}_{ᵢ}) is a constant with respect to the variable θᵢ. Therefore, when traversing all the terms that satisfy i≠t, the result is the above equation. The sharpness can therefore be alternatively estimated as follows:

$${𝔼}_{{θ}_{i} ∼ Unif ( Θ )} [ {γ}_{i} {R}_{{𝔹}_{t}} ( {f}_{{θ}_{i}} ) {R}_{{𝔹}_{t}} ( {f}_{{θ}_{i}} ) ] \approx {𝔼}_{{θ}_{i} ∼ Unif ( Θ )} [ {η}_{i} cos ( {Φ}_{i} ) ‖ {∇}_{{θ}_{i}} {L}_{i} ( {f}_{{θ}_{i}} ) ‖ ‖ {∇}_{{θ}_{i}} {L}_{i} ( {f}_{{θ}_{i}} ) ‖ ] = {𝔼}_{{θ}_{i} ∼ Unif ( Θ )} [ {η}_{i} {∇}_{{θ}_{i}} {{L}_{i} ( {f}_{{θ}_{i}} )}^{T} {∇}_{{θ}_{i}} {L}_{i} ( {f}_{{θ}_{i}} ) ] \approx {𝔼}_{{θ}_{i} ∼ Unif ( Θ )} [ {L}_{i} ( {f}_{{θ}_{i}} ) - {L}_{i} ( {f}_{{θ}_{i + 1}} ) ] = \frac{1}{t - 1} [ {L}_{t} ( {f}_{{θ}_{1}} ) - {L}_{t} ( {f}_{{θ}_{t}} ) ] .$$

Minimizing the loss difference Lₜ(f_{θ}_{₁})−Lₜ(f_{θ}_{ₜ}) corresponds to minimizing the SAM's sharpness measure Rₜ (f_{θ}_{ₜ}). Accordingly, since no additional computational overhead is needed, the training loss difference can be used as a proxy to the loss Rₜ(f_{θ}_{ₜ}) from SAM to quantify and penalize the sharpness. The loss function may be expressed as:

$${ℒ}_{fsacf} ( Θ ) = {\sum }_{( u , i , j ) ϵ𝒪} - ln σ ( {\hat{y}}_{ui} - {\hat{y}}_{uj} ) + α {‖ Θ ‖}_{2}^{2} + λ \frac{1}{\vert B \vert} {‖ {Y}_{e} - {Y}_{e - E} ‖}_{F}^{2} ,$$

Non-limiting embodiments provide for adversarial training that avoids sudden drops in the loss in the sharp local minima by minimizing the trajectory loss based on the difference between the outputs of models with current and past weights. This loss captures the rate of change of the training loss along the update trajectory of the model, thereby providing convergence to a flat minimum with improved capabilities to be generalized to different types of data.

Non-limiting embodiments described herein may be used for training a collaborative filtering model of any type. For example, in some non-limiting embodiments, the trained model may provide ranked recommendations for different merchants and/or products to a consumer (e.g., such as an account holder). This may include, for example, restaurant recommendations, media recommendations, content recommendations, and automated customization of services, advertisements, and/or graphical user interfaces.

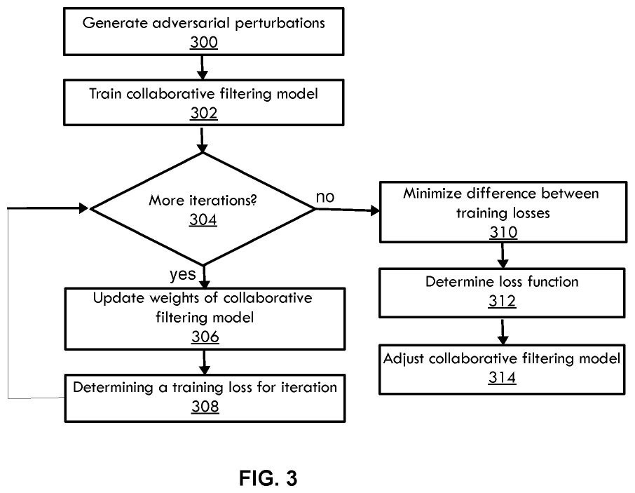

Referring now to FIG. 3, shown is a flow diagram for a method for adversarial training for collaborative filtering according to non-limiting embodiments or aspects. The steps shown in FIG. 3 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

At step 300, adversarial perturbations are generated. In non-limiting embodiments, a data set of adversarial perturbations may be preexisting and retrieved from storage and/or another system. In non-limiting embodiments, dynamic perturbations may be generated ad hoc for the training process.

At step 302, training of a collaborative filtering model may be commenced as a series of multiple training iterations. Each iteration may train the model based on one or more of the adversarial perturbations. At step 304, it is determined whether there are more training iterations to process (e.g., if there are additional adversarial perturbations to train with or if a threshold number of iterations has been reached).

For each iteration identified at step 304, steps 306 and 308 may be performed. At step 306, weights associated with the collaborative filtering model (e.g., node weights in a network, edge weights, and/or the like) may be updated for that iteration and based on the one or more adversarial perturbations of that iteration. At step 308, a training loss for that iteration is determined and stored in memory. The method may return to step 304 to loop back through steps 306 and 308 or, if there are no further iterations, to step 310.

At step 310, the difference between the training losses from all of the iterations is minimized. For example, a trajectory of all of the training losses (e.g., weights) for all of the iterations may be identified by determining the difference between each individual training loss, and the trajectory from all the losses may be minimized. The trajectory may, for example, be determined based on angles between gradients from each iteration of the plurality of iterations.

At step 312, a loss function is determined based on the minimized trajectory of the plurality of losses. At step 314, the loss function is used to train the collaborative filtering model. In some examples, the loss function may be used to adjust a model output, provide a confidence score for a model output, provide an explanation for a model output, and/or the like. As an example, the loss function may be used to compare the output of the collaborative filtering model to a target output, thereby measuring the robustness of the collaborative filtering model with respect to the training data. To train based on the loss function, various methods may be used such but not limited to backpropagation. The training at step 314 may be adjustments to the collaborative filtering model that are in addition to the adjustments made at step 306 for each iteration of updating the weights of the collaborative filtering model.

In non-limiting embodiments, the loss determined at step 312 may be used to provide an explainability of an output from the collaborative filtering model. For example, based on the trajectory of the losses, a loss landscape may be determined based on the smoothness of the trajectory. From the loss landscape, the robustness and/or performance of the collaborative filtering model may be improved.

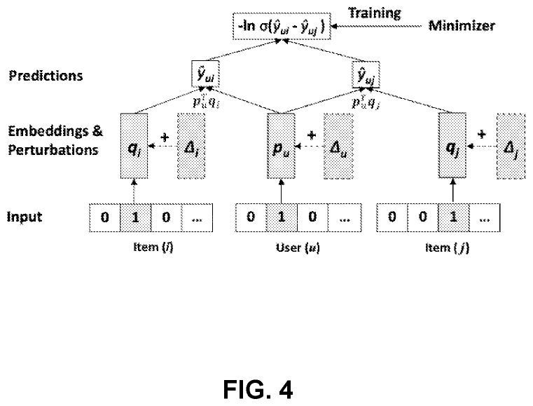

Referring now to FIG. 4, shown is a schematic diagram for a system for adversarial training for collaborative filtering according to non-limiting embodiments or aspects. As shown, the perturbations Δ are enforced on each embedding vector of user u and item i. The loss between the predicted scores ŷᵤᵢ resulting from each perturbation and/or iteration is minimized as shown. The user embeddings in FIG. 4 are represented by pᵤ and the item embeddings are represented by as qᵢ, for a total of j iterations. The inner product for each combination of user and item vectors, for each perturbed iteration, provides scores ŷᵤᵢ that serve as the basis for the loss determinations.

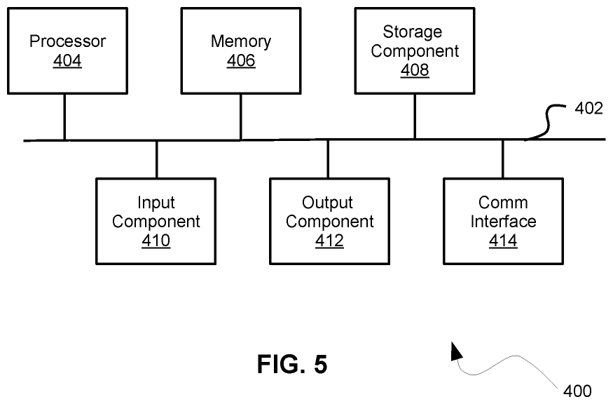

Referring now to FIG. 5, shown is a diagram of example components of a device 400 according to non-limiting embodiments or aspects. Device 400 may correspond to the computing device 102, service 202, and/or other system components shown and described in connection with FIGS. 1 and 2. In non-limiting embodiments or aspects, such systems or devices may include at least one device 400 and/or at least one component of device 400. The number and arrangement of components shown in FIG. 5 are provided as an example. In non-limiting embodiments or aspects, device 400 may include additional components, fewer components, different components, or differently arranged components than those shown. Additionally, or alternatively, a set of components (e.g., one or more components) of device 400 may perform one or more functions described as being performed by another set of components of device 400.

Device 400 may include bus 402, processor 404, memory 406, storage component 408, input component 410, output component 412, and communication interface 414. Bus 402 may include a component that permits communication among the components of device 400. In non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

Storage component 408 may store information and/or software related to the operation and use of device 400. For example, storage component 408 may include a hard disk (e.g., a magnetic disk, an optical disk, a magneto-optic disk, a solid state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally, or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A system comprising at least one processor programmed or configured to:
train a collaborative filtering model through a plurality of iterations by inputting a training data set comprising adversarial perturbations;
update weights of the collaborative filtering model after each iteration or subset of iterations of the plurality of iterations;
determine a training loss between each consecutive iteration or subset of iterations of the plurality of iterations, resulting in a plurality of training losses; and
determine a loss function for the collaborative filtering model by minimizing a difference between an initial training loss and the plurality of training losses for the plurality of iterations.

2. The system of claim 1, wherein minimizing the difference comprises minimizing a trajectory of the plurality of training losses for the plurality of iterations.

3. The system of claim 2, wherein the at least one processor is further configured to determine the trajectory of the plurality of training losses based on angles between gradients from the plurality of iterations.

4. The system of claim 1, wherein the at least one processor is further configured to train the collaborative filtering model based on the loss function.

5. The system of claim 1, wherein the at least one processor is further configured to generate a recommendation of an item for a user based on the collaborative filtering model.

6. The system of claim 1, wherein the loss function is based on a sharpness measure of the plurality of training losses.

7. The system of claim 1, wherein the training data set comprises a plurality of vectors representing a plurality of matrices, each matrix representing a user and an item from a plurality of users and a plurality of items.

8. A method comprising:
training, with at least one processor, a collaborative filtering model through a plurality of iterations by inputting a training data set comprising adversarial perturbations;
updating, with at least one processor, weights of the collaborative filtering model after each iteration or subset of iterations of the plurality of iterations;
determining, with at least one processor, a training loss between each consecutive iteration or subset of iterations of the plurality of iterations, resulting in a plurality of training losses; and
determining, with at least one processor, a loss function for the collaborative filtering model by minimizing a difference between an initial training loss and the plurality of training losses for the plurality of iterations.

9. The method of claim 8, wherein minimizing the difference comprises minimizing a trajectory of the plurality of training losses for the plurality of iterations.

10. The method of claim 9, wherein the trajectory of the plurality of training losses is determined based on angles between gradients from the plurality of iterations.

11. The method of claim 8, further comprising training the collaborative filtering model based on the loss function.

12. The method of claim 8, further comprising generating a recommendation of an item for a user based on the collaborative filtering model.

13. The method of claim 8, wherein the loss function is based on a sharpness measure of the plurality of training losses.

14. The method of claim 8, wherein the training data set comprises a plurality of vectors representing a plurality of matrices, each matrix representing a user and an item from a plurality of users and a plurality of items.

15. A computer program product comprising at least one non-transitory computer-readable medium including program instructions that, when executed by at least one processor, cause the at least one processor to:
train a collaborative filtering model through a plurality of iterations by inputting a training data set comprising adversarial perturbations;
update weights of the collaborative filtering model after each iteration or subset of iterations of the plurality of iterations;
determine a training loss between each consecutive iteration or subset of iterations of the plurality of iterations, resulting in a plurality of training losses; and
determine a loss function for the collaborative filtering model by minimizing a difference between an initial training loss and the plurality of training losses for the plurality of iterations.

16. The computer program product of claim 15, wherein minimizing the difference comprises minimizing a trajectory of the plurality of training losses for the plurality of iterations.

17. The computer program product of claim 16, wherein the instructions further cause the at least one processor to determine the trajectory of the plurality of training losses based on angles between gradients from the plurality of iterations.

18. The computer program product of claim 15, wherein the instructions further cause the at least one processor to train the collaborative filtering model based on the loss function.

19. The computer program product of claim 15, wherein the instructions further cause the at least one processor to generate a recommendation of an item for a user based on the collaborative filtering model.

20. The computer program product of claim 15, wherein the loss function is determined as:
$${ℒ}_{fsacf} ( Θ ) = {\sum }_{( u , i , j ) ϵ𝒪} - ln σ ( {\hat{y}}_{ui} - {\hat{y}}_{uj} ) + α {‖ Θ ‖}_{2}^{2} + λ \frac{1}{\vert B \vert} {‖ {Y}_{e} - {Y}_{e - E} ‖}_{F}^{2}$$
